(19) United States
(12) Patent Application Publication
(10) Pub. No.: US 2022/0309597 A1
(43) Pub. Date: Sep. 29, 2022

(54) COMPUTER VISION FRAMEWORK FOR REAL ESTATE

(71) Applicant: REAI, INC., Duluth, GA (US)

(72) Inventors: James Wang, Duluth, GA (US); Siddharth Biswal, Duluth, GA (US)

(21) Appl. No.: 17/656,781

(22) Filed: Mar. 28, 2022

Related U.S. Application Data
(60) Provisional application No. 63/167,602, filed on Mar. 29, 2021.

(51) Int. Cl. G06Q 50/16; G06Q 30/06; G06V 10/86; G06V 10/82; G06V 20/70; G06V 10/764; G06V 10/74

(52) U.S. Cl. CPC G06Q 50/16; G06Q 30/0631; G06V 10/86; G06V 10/82; G06V 20/70; G06V 10/764; G06V 10/761

(57) ABSTRACT

Image processing apparatuses and systems implementing deep learning architectures that can learn high-quality representations of images (e.g., of real estate images of properties) are described. The described techniques may be implemented to generate high-quality image representations may be used for various downstream applications including improved image captioning applications, improved image labeling applications, improved image search applications, etc. For instance, image representations generated according to one or more aspects of the described techniques may be used for image (e.g., real estate/property) classification, automatic property listing generation based on one or more images, property or listing recommendations based on searched images, etc. Moreover, the image processing systems described herein may be interpretable, which may be useful for designing or improving applications such as real estate appraisal, real estate interior design, and real estate renovation, real estate insurance, among other examples.

### CROSS-REFERENCE TO RELATED APPLICATION

This application claims priority from Provisional Patent Application No. 63/167,602 filed on Mar. 29, 2021, in the United State Patent and Trademark Office, and all the benefits accruing therefrom under 35 U.S.C. 119, the contents of which in their entirety are herein incorporated by reference.

### BACKGROUND

The following relates generally to artificial intelligence, and more specifically to computer vision framework for real estate.

Images and videos are one of the primary ways to convey visual information. For example, in the real estate industry, images may often be used to showcase properties and convey extensive information such as property condition, property size, property location, etc. For instance, buyers may look at many different images of a house to get an understanding of the property (e.g., before making any decision on scheduling tour, later making offering, etc.).

In addition to modern mobile devices and web searches enabling users to look at many different real estate images, there are also many images publicly available (e.g., such as images uploaded to multiple listing services (MLS) websites by real estate agents, etc.). These images include a lot of information such the type of the room, objects in the rooms, condition of the room or house, architectural style of the house, building material, flooring type, etc. In various cases, such information may not be directly/manually extracted by human curators (e.g., as every month there are more than tens of millions of property related images uploaded at various MLS platforms).

Such information may be important for many applications, for example, for buyers to quickly sift through properties by images. There is a need in the art for more efficient extraction of information from such images.

### SUMMARY

A method, apparatus, non-transitory computer readable medium, and system for implementing a computer vision framework for real estate applications are described. One or more aspects of the method, apparatus, non-transitory computer readable medium, and system include receiving an image of a real estate property and a real estate knowledge graph, wherein the knowledge graph includes nodes representing property attributes and relationships between the nodes; encoding the image based on the knowledge graph to obtain an embedded representation of the image or video; and generating a natural language description of the real estate property based on the embedded representation of the image or video.

A method, apparatus, non-transitory computer readable medium, and system for implementing a computer vision framework for real estate applications are described. One or more aspects of the method, apparatus, non-transitory computer readable medium, and system include receiving an image of a real estate property and a real estate knowledge graph, wherein the knowledge graph includes nodes representing property attributes and relationships between the nodes; encoding the image based on the knowledge graph to obtain an embedded representation of the image; receiving a search query that includes attributes of the real estate property; and retrieving the image based on the search query and the embedded representation of the image.

An apparatus, system, and method for implementing a computer vision framework for real estate applications are described. One or more aspects of the apparatus, system, and method include a knowledge transformer network configured to encode a real estate knowledge graph comprising nodes representing property attributes and relationships between the nodes to obtain an embedded knowledge representation; an image encoder configured to encode an image of a real estate property based on the embedded knowledge representation to obtain an embedded representation of the image; and a caption network configured to generate a natural language description of the real estate property based on the embedded representation of the image.

### BRIEF DESCRIPTION OF THE DRAWINGS

FIGS. 1 and 2 show examples of an image processing system according to aspects of the present disclosure.

FIG. 3 shows an example of an image processing apparatus according to aspects of the present disclosure.

FIG. 4 shows an example of a knowledge graph according to aspects of the present disclosure.

FIGS. 5 and 6 show examples of an image processing system according to aspects of the present disclosure.

FIG. 7 shows an example of an image labeling diagram according to aspects of the present disclosure.

FIGS. 8 and 9 show examples of an image processing system according to aspects of the present disclosure.

FIG. 10 shows a flowchart for an example image search application according to aspects of the present disclosure.

FIGS. 11 and 12 show examples of methods for artificial intelligence according to aspects of the present disclosure.

### DETAILED DESCRIPTION

Available real estate information often includes data such as images and videos for properties, among other information. Such images and videos inherently capture useful real estate/property information for various applications (e.g., for buyers, sellers, real estate agents, insurance agents, investors, etc.).

According to the techniques described herein, image processing systems may implement deep learning architectures that can learn high-quality representations of images (e.g., of real estate images of properties), where such high-quality image representations may be used for various downstream applications including improved image captioning applications, improved image labeling applications, improved image search applications, etc. For instance, image representations generated according to one or more aspects of the described techniques may be used for image (e.g., real estate/property) classification, automatic property listing generation based on one or more images, property or listing recommendations based on searched images, etc. Moreover, the image processing systems described herein may be interpretable, which may be useful for designing or improving applications such as real estate appraisal, real estate interior design, real estate renovation, and real estate insurance, among other examples.

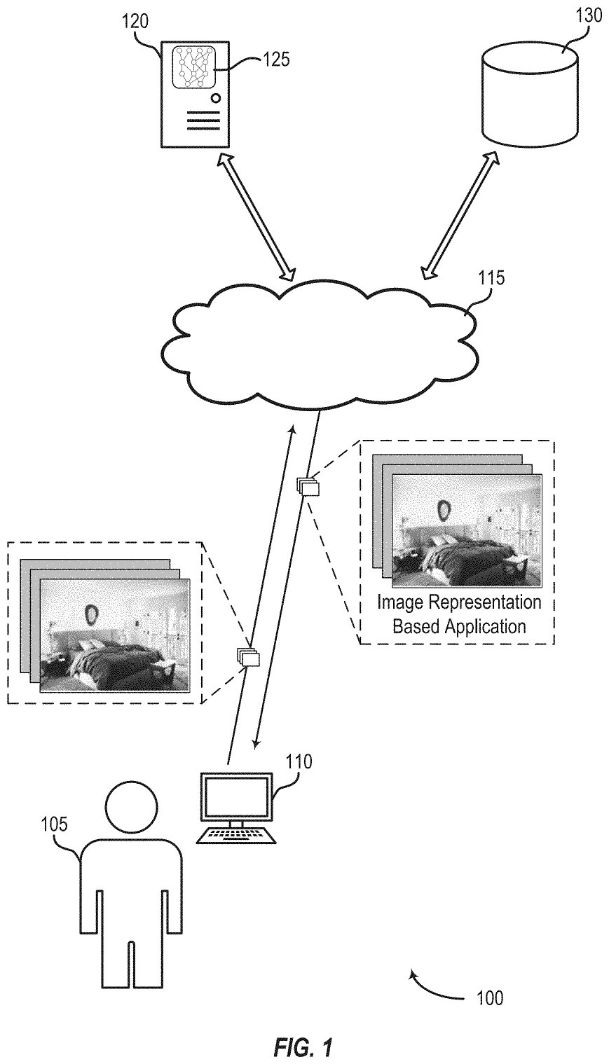

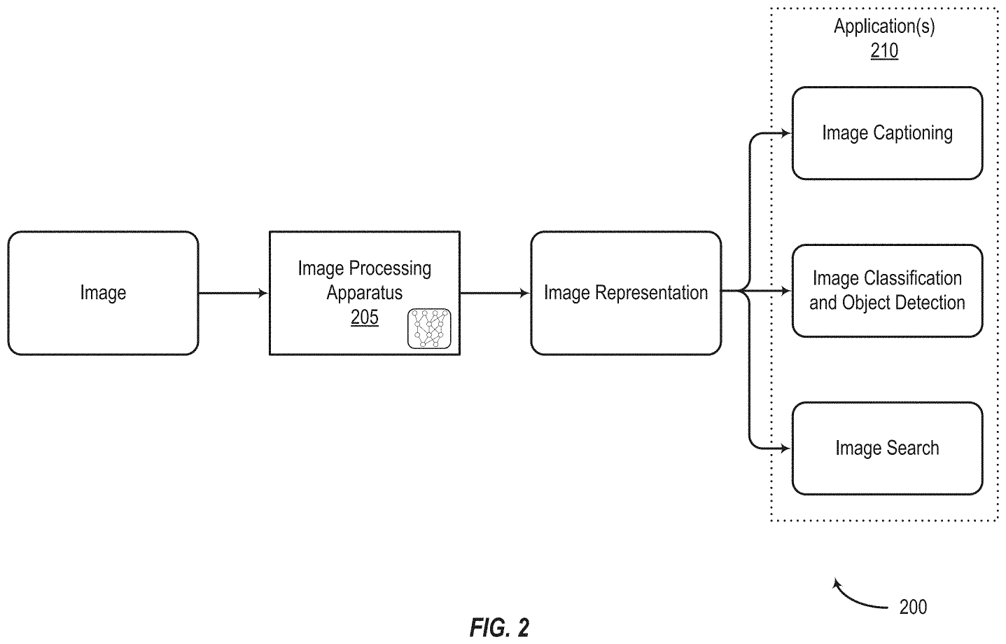

FIG. 1 shows an example of an image processing system 100 according to aspects of the present disclosure. Image processing system 100 is an example of, or includes aspects of, the corresponding element described with reference to FIGS. 2, 5, 6, 8, and 9. In one aspect, image processing system 100 includes user 105, device 110, cloud 115, image processing apparatus 120, and database 130. Image processing apparatus 120 is an example of, or includes aspects of, the corresponding element described with reference to FIGS. 2, 3, 6, and 8.

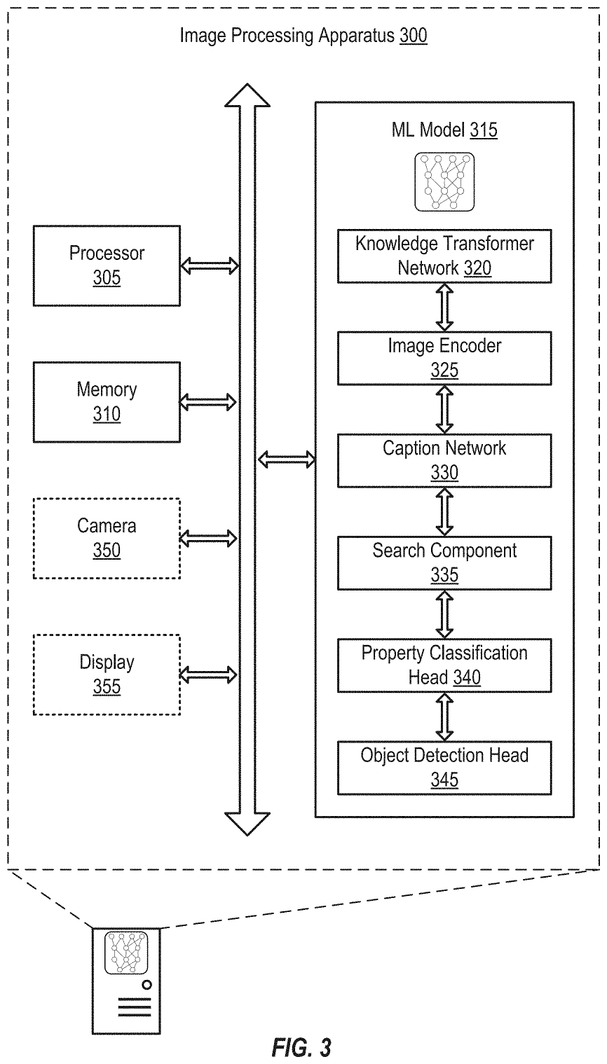

In one aspect, image processing apparatus 120 includes ML model 125. ML model 125 is an example of, or includes aspects of, the corresponding element described with reference to FIG. 3. Generally, ML model 125 (e.g., a neural network) is a type of computer algorithm that is capable of learning specific patterns without being explicitly programmed, but through iterations over known data. ML model 125 may refer to a cognitive model that includes input nodes, hidden nodes, and output nodes. Nodes in the ML model 125 may have an activation function that computes whether the node is activated based on the output of previous nodes. Training the system may involve supplying values for the inputs, and modifying edge weights and activation functions (algorithmically or randomly) until the result closely approximates a set of desired outputs. Various aspects of ML model 125 are described in more detail herein.

In some cases (e.g., as described in more detail herein), ML model 125 may implement one or more aspects of natural language processing (NLP). NLP refers to techniques for using computers (e.g., such as image processing apparatus 120) to interpret or generate natural language. In some cases, NLP tasks involve assigning annotation data such as grammatical information to words or phrases within a natural language expression. In an NLP context, annotation information refers to data (e.g., data about the meaning and structure) of an image, for example, using natural language phrases. Examples of annotation information include grammatical structure information or semantic information (i.e., information about the meaning of a sentence or an image that is more easily interpretable by an automated system, such as the image processing system 100).

For instance, in the example of FIG. 1, image processing apparatus 120 may annotate an input image with grammatical information such as real estate labels (e.g., bedroom), detected objects (e.g., bed, dresser, sofa, table, refrigerator, etc.), conditions or labels (e.g., large/small, clean/damaged, color information, layout or organization information), etc. Generally, image processing apparatus 120 may implement one or more aspects of the techniques described herein for image captioning applications, image labeling applications, image search applications, etc. (e.g., as described in more detail herein, for example, with reference to FIG. 2).

Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features. These models can express the relative probability of multiple answers.

The device 110 may include any computing device, such as a personal computer, a laptop computer, a mainframe computer, a palmtop computer, a personal assistant, a mobile device, or any other suitable processing apparatus. In some cases, the device 110 and image processing apparatus 120 may be implemented as a single device. For example, one or more aspects of the techniques described herein may be implemented on a single device (e.g., image processing apparatus 120 itself may obtain images, handle various processing aspects independently, display output information such as annotated images, etc.).

A cloud 115 is a computer network configured to provide on-demand availability of computer system resources, such as data storage and computing power. In some examples, the cloud 115 provides resources without active management by the user 105. The term cloud is sometimes used to describe data centers available to many users 105 over the Internet. Some large cloud networks have functions distributed over multiple locations from central servers. A server is designated an edge server if it has a direct or close connection to a user 105. In some cases, a cloud 115 is limited to a single organization. In other examples, the cloud 115 is available to many organizations. In one example, a cloud 115 includes a multi-layer communications network comprising multiple edge routers and core routers. In another example, a cloud 115 is based on a local collection of switches in a single physical location.

In some examples, image processing apparatus 120 may include, or implement one or more aspects of, a server. A server provides one or more functions to users 105 linked by way of one or more of the various networks. In some cases, the server includes a single microprocessor board, which includes a microprocessor responsible for controlling all aspects of the server. In some cases, a server uses microprocessor and protocols to exchange data with other devices 110/users 105 on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

A database 130 is an organized collection of data. For example, a database 130 stores data in a specified format known as a schema. A database 130 may be structured as a single database 130, a distributed database 130, multiple distributed databases 130, or an emergency backup database 130. In some cases, a database controller may manage data storage and processing in a database 130. In some cases, a user 105 interacts with database 130 via a database controller. In other cases, a database controller may operate automatically without user 105 interaction.

Generally, input images may be obtained from (e.g., and often may be publicly available from) listing data, neighborhood data, historical price change data per properties, tax history of properties, commercial properties in a neighborhood, crime activities in a neighborhood, schools and the quality of the schools in a neighborhood, social hotspots in a neighborhood, location of major businesses around the neighborhood and the distance of major businesses from the center of the neighborhood and from each property, new development planned or in process, new zoning regulation, new transportation (highway, roads, etc.) planned or in process, new shopping area planned or in process, new major incidents, accidents around the neighborhood, etc.

In some cases, device 110 may leverage image processing apparatus 120 for various pricing trend based applications. As an example, image processing apparatus 120 may: identify historical information for a property or a neighborhood, predict future trend information for the property or neighborhood based on the historical information (and other related information) using a machine learning model, generate a visual indication for the future trend information, overlay the visual indication on a map (e.g., and, in some cases, overlay additional visual indications for additional properties or neighborhoods on the map, where the visual indication may include a heatmap using colors and different shades to indicate the future trend information).

In some cases, device 110 may leverage image processing apparatus 120 for various safety based applications. As an example, image processing apparatus 120 may: identify a plurality of safety factors for a property or a neighborhood, predict a safety rating for the property or neighborhood by inputting the plurality of safety factors into a machine learning model, generate a visual indication of the safety rating, and overlay the visual indication on a map (e.g., and, in some cases, overlay additional visual indications for additional properties or neighborhoods on the map, where the visual indication may include a color indicating the safety rating).

In some examples, one or more aspects of the techniques described herein may be implemented to generate listings, generate offers (e.g., generate property purchase offers based on property conditions), etc. For instance, various listing terms, offering terms (e.g., determination of offer terms based on one or more real estate images), etc. may be generated based on images or video. In some aspects, future renovations, insurance details, etc. may also be determined or projected based on images and/or video.

FIG. 2 shows an example of an image processing system 200 according to aspects of the present disclosure. Image processing system 200 is an example of, or includes aspects of, the corresponding element described with reference to FIGS. 1, 5, 6, 8, and 9. In one aspect, image processing system 200 includes image processing apparatus 205 and applications 210. Image processing apparatus 205 is an example of, or includes aspects of, the corresponding element described with reference to FIGS. 1, 3, 6, and 8.

In the example of FIG. 2, image processing apparatus 205 may generate an image representation from an image (e.g., image processing apparatus 205 may encode an image based on a knowledge graph to obtain an embedded representation of the image, as described in more detail herein). An embedded representation of an image (e.g., the image representation) may include or refer to a learned representation for the image where aspects of the image that have the same or similar meaning as other image aspects have a similar representation (e.g., architecture aspects of an embedded image may have a similar representation in a vector space compared to similar architecture aspects of other embedded images). For example, for real estate applications 210 (e.g., applications 210 implemented in the context of real estate applications), image processing apparatus 205 may generate embedded representations of real estate images such that aspects of the input images (e.g., aspects of the image relevant to real estate applications 210, such as property types, property conditions, other property information, etc.) have the same meaning have a similar representation in the embedded space (e.g., in the learned vector space).

In some aspects, applications 210 may include (or implement) software. For instance, software may include code to implement aspects of the present disclosure. Software may be stored in a non-transitory computer-readable medium such as system memory or other memory. In some cases, the software may not be directly executable by the processor but may cause a device (e.g., when compiled and executed) to perform functions described herein.

In some aspects, image processing apparatus 205 my implement one or more aspects of object detection techniques to generate an image representation of an image. Object detection refers to a computer-implemented program to classify objects using categorical labels and localize objects present in input images. Object detection can be performed and evaluated by mean average precision, a metric taking into account a quality of classification and localization. In some examples, computer vision applications 210 perform object detection to analyze image data, e.g., to identify people or objects in an image.

In some aspects, image processing apparatus 205 my implement one or more aspects of image segmentation techniques to generate an image representation of an image. In digital image processing and computer vision, image segmentation is the process of partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics.

In some aspects, image processing apparatus 205 receive, or be configured with, a vector space. In some examples, image processing apparatus 205 may take a large set of images (e.g., real estate images) and produce a vector space as output. In some cases, the vector space may have a large number of dimensions. Image vectors of the generated image representation are positioned in the vector space in a manner such that similar image aspects are located nearby in the vector space.

Image captioning applications 210 may generally include, or refer to, processes where image processing apparatus 205 (e.g., a computer vision engine) obtains (e.g., captures, or is provided with) an image input and generates an image representation used to output (e.g., generate, extract, etc.) a sentence with the description or advanced information from the image. For instance, in the real estate industry, because of various circumstances and complexities of listing images, it may not be feasible to manually generate captioning describing images, to manually provide guidance as to the condition of the underlying property, to manually recommend listings or property options to users (e.g., buyers) based on the property image, manually search listings/properties based on input images, etc. Image captioning applications 210, according to the techniques described herein, may be useful for producing readable descriptions for images (e.g., for real estate image captioning applications 210). In some aspects, such image captioning applications 210 may be helpful for visually impaired or disabled users (e.g., real estate buyers, real estate sellers, etc.), as image captioning applications 210 may provide the information desired to comprehend real estate images for various needs. As described in more detail herein, a specialized knowledge graph for real estate applications 210 may be used to generate captions for images.

Image labeling applications 210 may include usage of machine learning-based predictive models to label property images correctly based on room types, architecture types, objects, features or other characteristics in rooms. Further, image labeling applications 210 and image labeling techniques described herein may serve to level condition information and analysis of rooms/property, recommendation of improvement of room/property based upon it, and non-compliance of listing images per real estate industry regulation and standards (e.g., as image labeling techniques described herein may serve as a consistent standard by which differing real estate images are analyzed and compared).

Image search applications 210 may enable users to conduct image search on properties, based on similarity of images, certain specific features of property/rooms from an image, or other characteristics from an image, and find their ideal choices of property or rooms, from the essence of the images. For instance, as described in more detail herein, image search applications 210 may enable users to input images (e.g., images of desired property types, property conditions, etc.) for searching related property listings more effectively.

FIG. 3 shows an example of an image processing apparatus 300 according to aspects of the present disclosure. Image processing apparatus 300 is an example of, or includes aspects of, the corresponding element described with reference to FIGS. 1, 2, 6, and 8. In one aspect, image processing apparatus 300 includes processor 305, memory 310, ML model 315, camera 350, and display 355. ML model 315 is an example of, or includes aspects of, the corresponding element described with reference to FIG. 1.

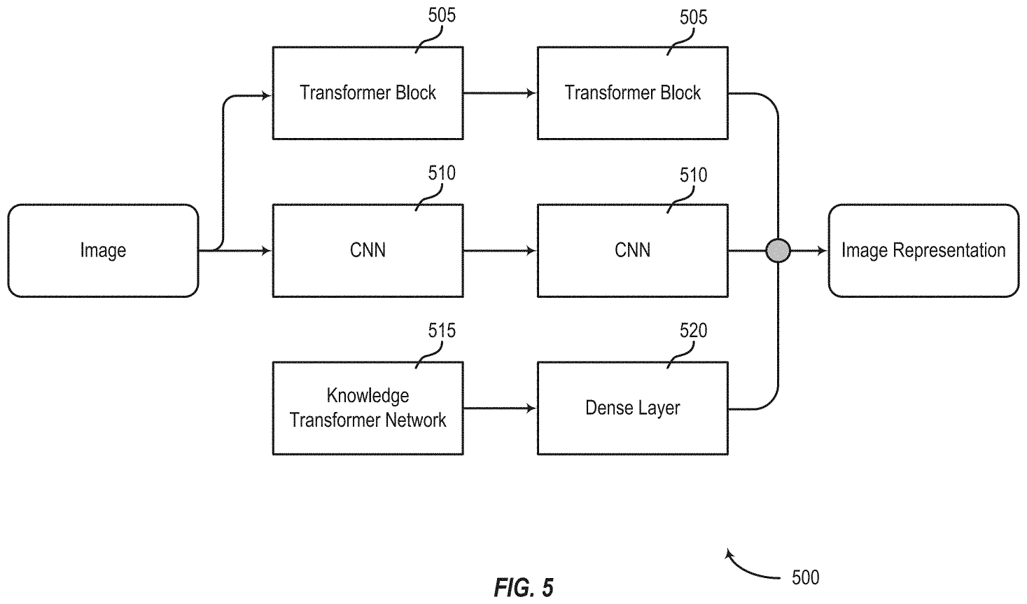

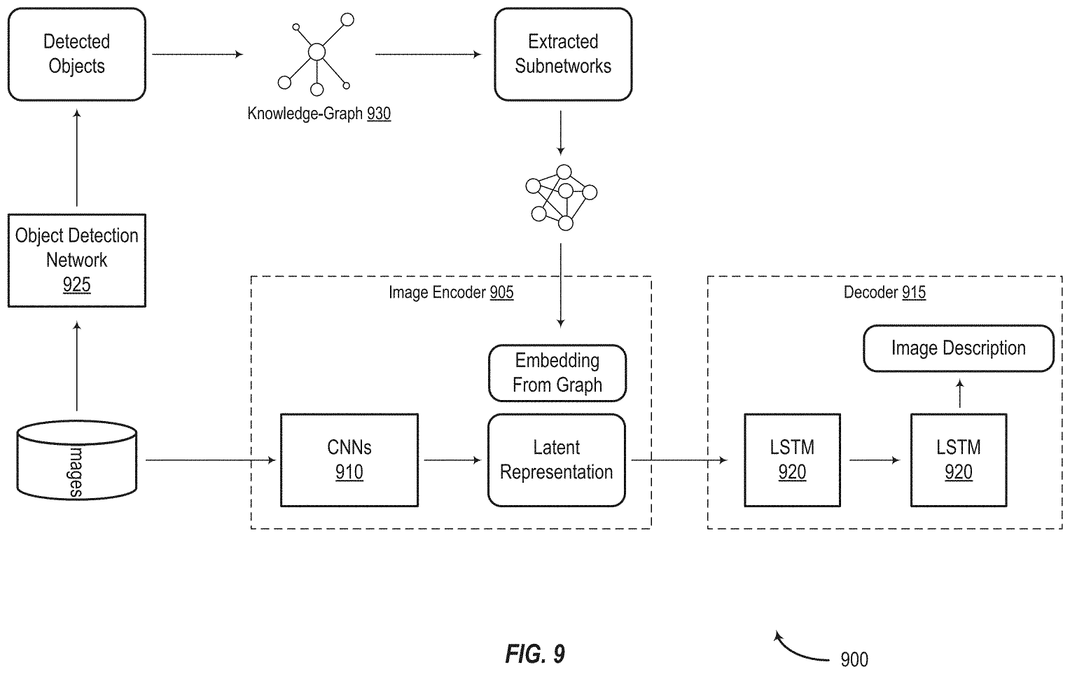

In one aspect, ML model 315 includes knowledge transformer network 320, image encoder 325, caption network 330, search component 335, property classification head 340, and object detection head 345. Knowledge transformer network 320 is an example of, or includes aspects of, the corresponding element described with reference to FIG. 5. Image encoder 325 is an example of, or includes aspects of, the corresponding element described with reference to FIG. 9. Object detection head 345 is an example of, or includes aspects of, the corresponding element described with reference to FIG. 9.

An apparatus (e.g., an image processing apparatus 300 for implementing a computer vision framework for real estate) is described. One or more aspects of the image processing apparatus 300 include a knowledge transformer network 320, an image encoder 325, and a caption network 330. In some aspects, the knowledge transformer network 320 is configured to encode a real estate knowledge graph comprising nodes representing property attributes and relationships between the nodes to obtain an embedded knowledge representation. In some aspects, the image encoder 325 is configured to encode an image of a real estate property based on the embedded knowledge representation to obtain an embedded representation of the image. In some aspects, the caption network 330 is configured to generate a natural language description of the real estate property based on the embedded representation of the image.

Some examples of the image processing apparatus 300 further include a search component 335 configured to retrieve the image based on a search query. Some examples of the image processing apparatus 300 further include a property classification head 340 configured to classify the image according to a set of real estate property types based on the embedded representation of the image. Some examples of the image processing apparatus 300 further include an object detection head 345 configured to identify an object in the image based on the embedded representation of the image.

A processor 305 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor 305 is configured to operate memory 310 (e.g., a memory array) using a memory controller. In other cases, a memory controller is integrated into the processor 305. In some cases, the processor 305 is configured to execute computer-readable instructions stored in a memory 310 to perform various functions. In some embodiments, a processor 305 includes special purpose components for modem processing, baseband processing, digital signal processing, or transmission processing.

Examples of memory 310 (e.g., a memory device) include random access memory (RAM), read-only memory (ROM), or a hard disk. Examples of memory devices further include solid state memory 310 and a hard disk drive. In some examples, memory 310 is used to store computer-readable, computer-executable software including instructions that, when executed, cause a processor 305 to perform various functions described herein. In some cases, the memory 310 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory 310 store information in the form of a logical state.

In some aspects, ML model 315 may include (e.g., or implement) an artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights may be adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

In some cases, ML model 315 may include (e.g., or implement) one or more aspects of a convolutional neural network (CNN). A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

In some cases, ML model 315 may include (e.g., or implement) one or more aspects of a recurrent neural network (RNN). A RNN is a class of ANN in which connections between nodes form a directed graph along an ordered (i.e., a temporal) sequence. This enables an RNN to model temporally dynamic behavior such as predicting what element should come next in a sequence. Thus, an RNN is suitable for tasks that involve ordered sequences such as text recognition (where words are ordered in a sentence). The term RNN may include finite impulse recurrent networks (characterized by nodes forming a directed acyclic graph), and infinite impulse recurrent networks (characterized by nodes forming a directed cyclic graph).

In some cases, ML model 315 may include (e.g., or implement) one or more aspects of a Logistic Regression Model. Logistic regression models may convert binary outcomes into probabilities. These can be extended to model multiple different classes. This model uses logistic function which is why this is called logistic regression. The input features for this model define the outcome obtained by the model.

In some cases, ML model 315 may include (e.g., or implement) one or more aspects of a Random Forest Model. A Random Forest Model is an ensemble learning method for classification regression type of tasks which models the data by constructing decision trees at the training time. At test time, the model outputs the class based on the decision trees constructed earlier.

As described herein, in some cases, techniques described herein may implement one or more aspects of neural networks. Neural networks are a class of machine learning models that use many different ways to describe the input feature and the connection between the weights to model the data. Neural Network models a concept of neuron which receives the input. In our neural network models, neurons receive different types of features such as the property price history, property images, tax history etc. Typically in neural networks, a propagation function is used, which computes the output from predecessor neurons and their connection as a weighted sum.

In some examples, image processing apparatus 300 may include a camera 350, which generally refers to any optical instrument, image sensor, etc. The camera 350 may be operable for recording or capturing images, which may be stored locally, transmitted to another location, etc. For example, camera 350 may capture visual information using one or more photosensitive elements that may be tuned for sensitivity to a visible spectrum of electromagnetic radiation. The resolution of such visual information may be measured in pixels, where each pixel may relate an independent piece of captured information. In some cases, each pixel may thus correspond to one component of, for example, a two-dimensional (2D) Fourier transform of an image. Computation methods may use pixel information to reconstruct images captured by the image processing apparatus 300. In a camera 350, an image sensor may convert light incident on a camera 350 lens into an analog or digital signal.

In some examples, image processing apparatus 300 may include a display 355. A display 355 may comprise a conventional monitor, a monitor coupled with an integrated display, an integrated display (e.g., an LCD display), or other means for viewing associated data or processing information. In some cases, output devices other than the display 355 can be used, such as printers, other computers or data storage devices, and computer networks.

According to some aspects, ML model 315 receives an image of a real estate property and a real estate knowledge graph, where the knowledge graph includes nodes representing property attributes and relationships between the nodes. According to some aspects, image encoder 325 encodes the image based on the knowledge graph to obtain an embedded representation of the image. In some examples, image encoder 325 encodes a user profile of a user to obtain an encoded user profile. According to some aspects, caption network 330 generates a natural language description of the real estate property based on the embedded representation of the image.

In some examples, ML model 315 identifies a set of room types and a set of objects within the room types, where the nodes of the knowledge graph include the set of room types and the set of objects within the room types. In some examples, ML model 315 performs a convolution operation (e.g., via CNN blocks described in more detail herein) on the image to obtain a convolution representation, where the embedded representation of the image is based on the convolution representation. In some examples, ML model 315 applies an RNN to the embedded representation of the image to obtain the natural language description.

In some examples, ML model 315 generates a recommendation score based on the embedded representation of the image and the encoded user 105 profile. In some examples, ML model 315 recommends the real estate property to the user 105 based on the recommendation score.

According to some aspects, knowledge transformer network 320 applies a transformer network to the image to obtain a transformer representation, where the embedded representation of the image is based on the transformer representation. In some examples, knowledge transformer network 320 applies a knowledge transformer network 320 to the knowledge graph to obtain an embedded representation of the knowledge graph, where the embedded representation of the image is based on the embedded knowledge representation.

In some examples, caption network 330 generates a real estate listing that includes the image and the natural language description. In some examples, caption network 330 generates a description of a maintenance condition of the real estate property based on the embedded representation of the image.

According to some aspects, search component 335 receives a search query that includes attributes of the real estate property. In some examples, search component 335 retrieves the image based on the search query and the embedded representation of the image. According to some aspects, image encoder 325 encodes the search query in a same embedding space as the image to obtain an encoded search query. In some examples, search component 335 generates a similarity score between the image and the search query, where the image is retrieved based on the similarity score. In some aspects, the search query includes an image, a text description, or both.

According to some aspects, property classification head 340 classifies the image based on a set of real estate property types based on the embedded representation of the image.

According to some aspects, object detection head 345 identifies an object attribute for each of the set of objects, where the nodes of the knowledge graph include the object attribute. In some examples, object detection head 345 performs object detection on the image based on the embedded representation of the image to obtain an image tag corresponding to an object represented in the knowledge graph.

According to some aspects, display 355 displays the real estate listing on a website.

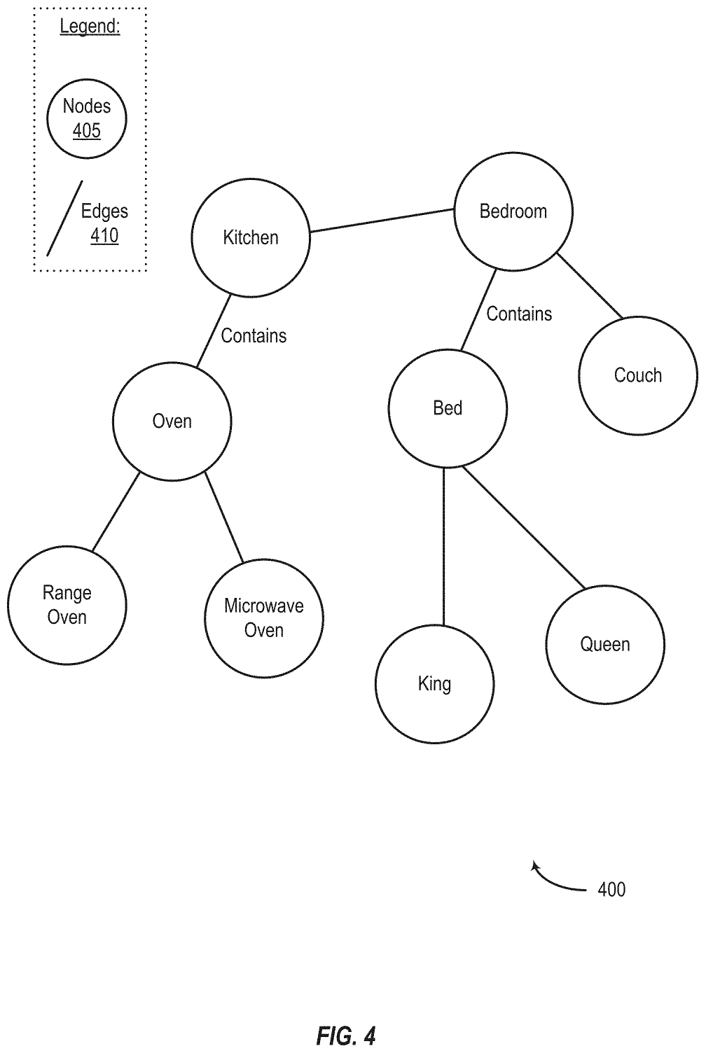

FIG. 4 shows an example of a knowledge graph according to aspects of the present disclosure. Knowledge graph representation 400 is an example of, or includes aspects of, the corresponding element described with reference to FIG. 9. In one aspect, knowledge graph representation 400 includes nodes 405 and edges 410.

The example knowledge graph representation 400 of FIG. 4 may illustrate one or more aspects of specialized graphs that use information from different real estate knowledge bases, according to techniques described herein. Such knowledge bases may include information about different objects and their relationship with each other. In some cases, a manual task of identifying different objects in a large set of images and extracting relationships between those images may be performed.

Graphs (e.g., such as the example knowledge graph representation 400) are one type of data structure that can be used to represent different relationships between entities. These relationships may be beneficial for encoding objects. For instance, in the case of real estate images, often images show different objects and their placement. In some implementations, objects may often grouped based on the type of room. For example, a kitchen usually has an oven, sink, etc. (e.g., where such objects may be detected and a knowledge graph representation 400 may suggest the image is of a kitchen).

For instance, in the example of FIG. 4, rooms, objects within the rooms, and in some cases, attributes of objects or rooms may be represented as nodes 405 of the knowledge graph representation 400. The relationship between these rooms, objects, and attributes (e.g., between nodes 405) may be represented as edges 410.

In some aspects, software may be implemented for the creation of initial graph data knowledge base. Once the graph knowledgebase is curated, a graph (e.g., a knowledge graph representation 400) may be extracted to use for the training process of a neural network for various applications and techniques described herein.

FIG. 5 shows an example of an image processing system 500 according to aspects of the present disclosure. Image processing system 500 is an example of, or includes aspects of, the corresponding element described with reference to FIGS. 1, 2, 6, 8, and 9. In one aspect, image processing system 500 includes transformer blocks 505, CNN blocks 510, knowledge transformer network 515, and dense layer 520. CNN blocks 510 is an example of, or includes aspects of, the corresponding element described with reference to FIG. 9. Knowledge transformer network 515 is an example of, or includes aspects of, the corresponding element described with reference to FIG. 3.

FIG. 5 shows an example image processing system 500 implementing a combination of transformers (e.g., transformer blocks 505) and CNNs (e.g., CNN blocks 510) to obtain an image representation from input images (e.g., embedded representation of one or more images of a real estate property) according to techniques described herein. For instance, images may be passed through multiple transformer blocks 505 and CNN blocks 510, and the images may be finally combined with the representation from a knowledge transformer (e.g., a knowledge transformer network 515) to generate a final representation (e.g., to output the embedded representation of the input image). This representation may use inherent information available in the image, as well as knowledge about real estate data hierarchy using the knowledge transformer network 515.

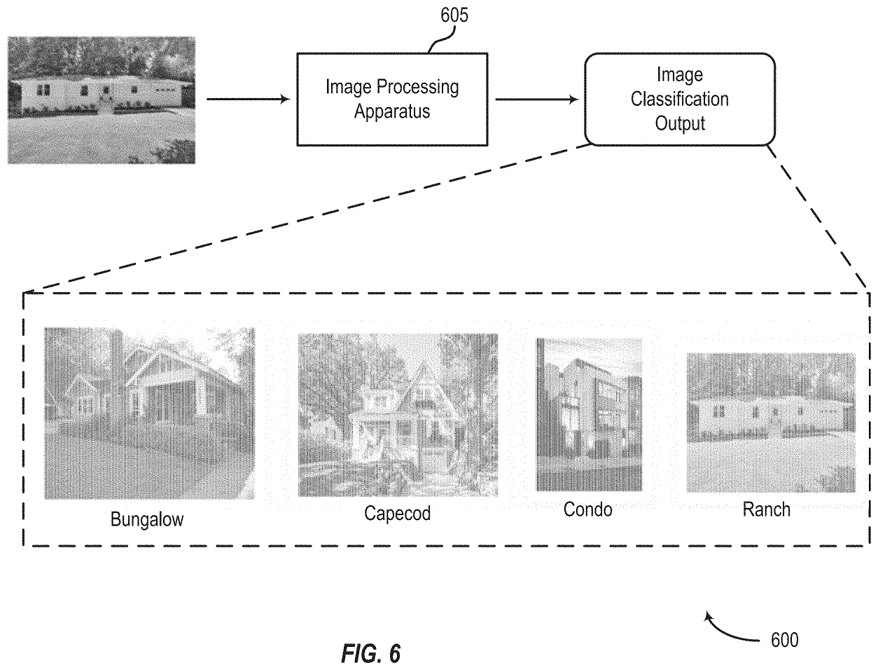

FIG. 6 shows an example of an image processing system 600 according to aspects of the present disclosure. Image processing system 600 is an example of, or includes aspects of, the corresponding element described with reference to FIGS. 1, 2, 5, 8, and 9. In one aspect, image processing system 600 includes image processing apparatus 605. Image processing apparatus 605 is an example of, or includes aspects of, the corresponding element described with reference to FIGS. 1-3, and 8.

In some cases, image processing apparatus 605 may be used for various image classification applications to extract, for example, different architectural styles and room type labels from one or more input images. As an example, for an example image classification pipeline of FIG. 6, a combination of self-supervised learning and traditional classification loss may be used to train a model. For instance, a self-supervised learning technique may be implemented to pre-train a neural network (e.g., a ML model of the image processing apparatus 605). In some aspects, different types of corruption may be employed to create labels for self-supervised training. Once this network is trained, the network may be used to further improve on larger data sets (e.g., larger data sets that may include actual labels).

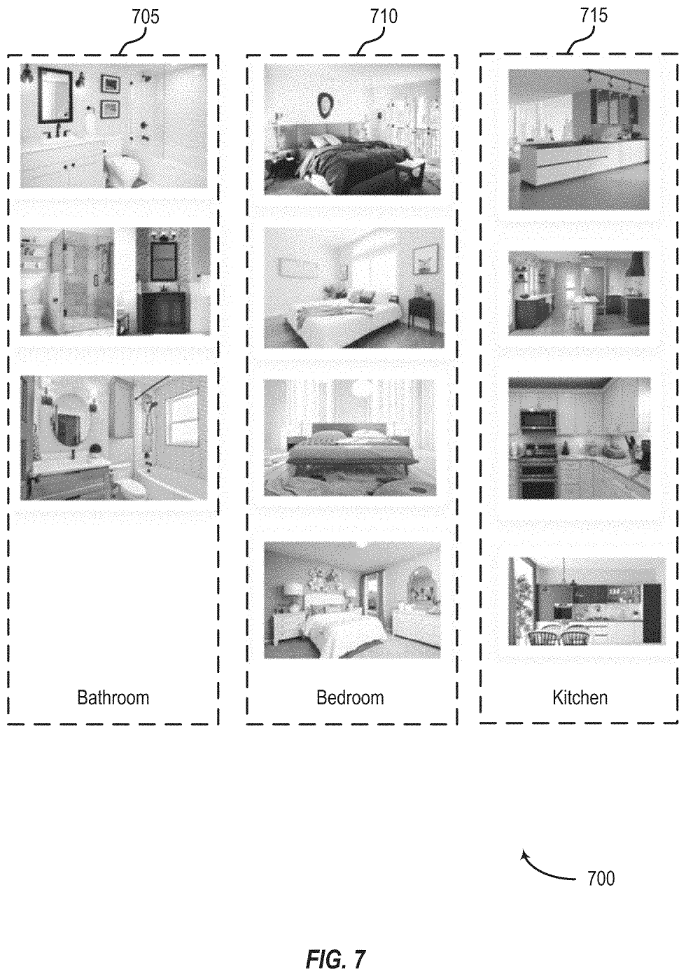

FIG. 7 shows an example of an image labeling diagram 700 according to aspects of the present disclosure. In one aspect, image labeling diagram 700 includes first set of labeled images 705, second set of labeled images 710, and third set of labeled images 715.

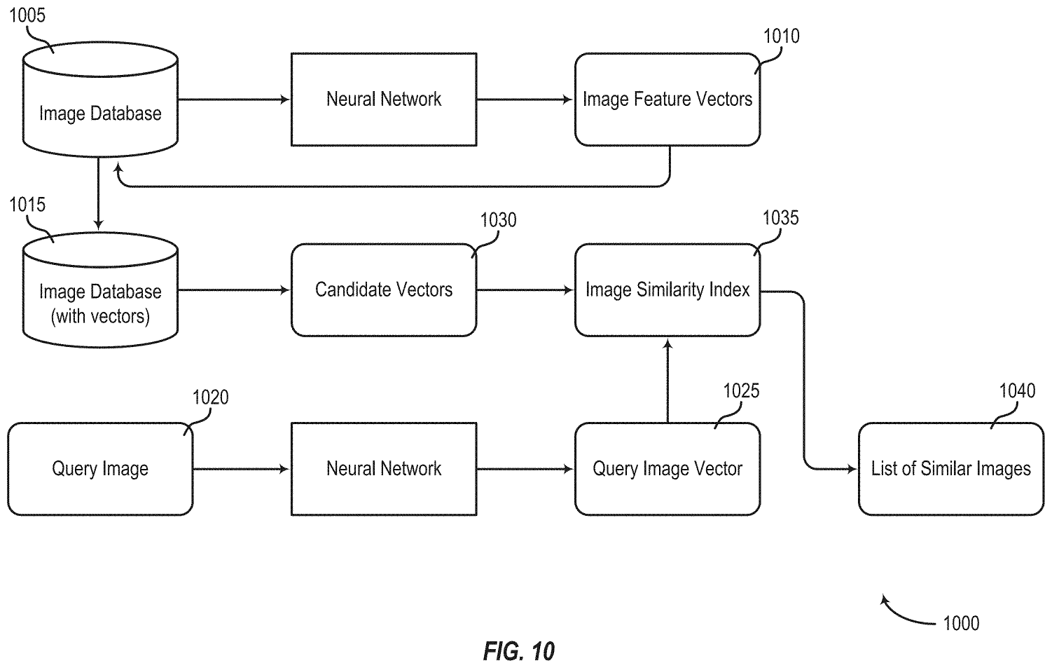

For example, techniques described herein (e.g., image classification/image labeling techniques described, for example, with reference to FIG. 6) may be implemented to label a set of images. In the example of FIG. 7, such techniques may be implemented to label or classify images into a first set of labeled images 705 (e.g., bathroom images), a second set of labeled images 710 (e.g., bedroom images), and third set of labeled images 715 (e.g., kitchen images). For instance, images may be processed, using an image processing apparatus described herein, to classify and label images based on objects detected in the images, etc. Such labeled images may be used for various applications described herein. For example, labeled images may be used to compare conditions of similar properties or room types, to appraise the value of property based on comparison with other similar labeled images, to search property listings for similar properties or room types based on an embedded search query and labeled candidate vectors (e.g., as described in more detail herein, for example, with reference to FIG. 10), etc.

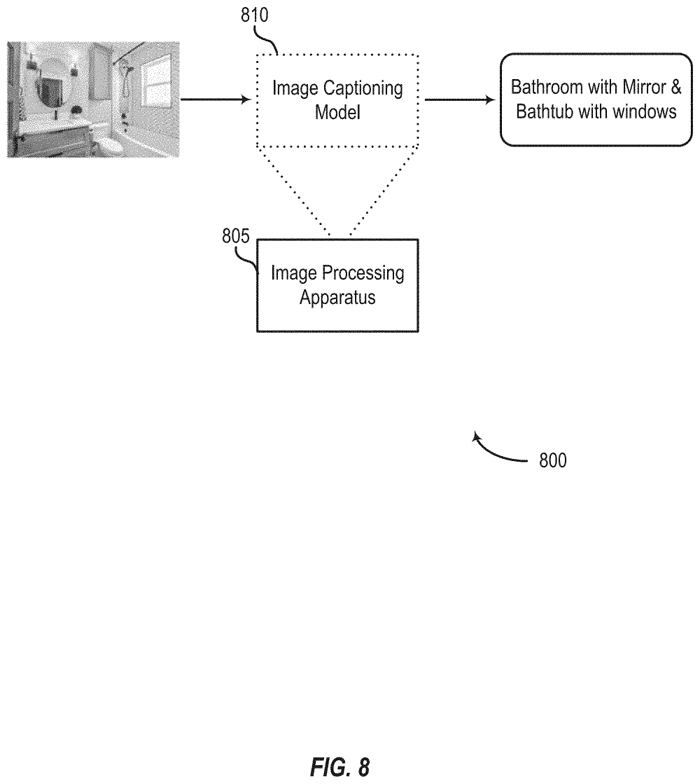

FIG. 8 shows an example of an image processing system 800 according to aspects of the present disclosure. Image processing system 800 is an example of, or includes aspects of, the corresponding element described with reference to FIGS. 1, 2, 5, 6, and 9. In one aspect, image processing system 800 includes image processing apparatus 805. Image processing apparatus 805 is an example of, or includes aspects of, the corresponding element described with reference to FIGS. 1-3, and 6. In one aspect, image processing apparatus 805 includes image captioning model 810.

According to techniques described herein, image captioning applications may be implemented for various real estate tasks (e.g., which may be important to help generate image descriptions that are useful to stakeholders in real estate transactions). In some aspects, image representations (e.g., obtained from an image processing apparatus 805) may be used to obtain the final description in the form of sentences, sometimes in paragraphs, etc. In some aspects, image captioning model 810 may use encoder and decoder models (e.g., where the encoder encodes images into a vector representation and the decoder decodes the vector representation into natural language description). In some cases, a pretrained transformer model may be used for the decoder (e.g., where words may be generated and the specific branch of the end-to-end model may be fine-tuned). Since the image processing apparatus 805 may generate a good (e.g., accurate, detailed, etc.) representation of the image (e.g., according to one or more aspects of techniques described herein), the decoder may generate a more accurate description (e.g., which may be more useful for particular implementations/applications).

FIG. 9 shows an example of an image processing system 900 according to aspects of the present disclosure. Image processing system 900 is an example of, or includes aspects of, the corresponding element described with reference to FIGS. 1, 2, 5, 6, and 8. In one aspect, image processing system 900 includes image encoder 905, decoder 915, object detection head 925, and knowledge graph representation 930. Image encoder 905 is an example of, or includes aspects of, the corresponding element described with reference to FIG. 3. In one aspect, image encoder 905 includes CNN blocks 910. CNN blocks 910 is an example of, or includes aspects of, the corresponding element described with reference to FIG. 5. In one aspect, decoder 915 includes LSTM blocks 920. Object detection head 925 is an example of, or includes aspects of, the corresponding element described with reference to FIG. 3. Knowledge graph representation 930 is an example of, or includes aspects of, the corresponding element described with reference to FIG. 4.

Image captioning models may take an image as input. Images may be denoted as X_i. In one example, the output of an image captioning model may be a sentence denoted as S+i=[w(1), . . . w(n)].

As an example, an input image may be represented as (X_i); an output caption may be represented as (S_i); training samples may be represented as {X_i, S_i}; and S_i={w_i1, w_i2, . . . w_in}. For such an example, a method is described, including:
Step 1: An image may be processed using a CNN (e.g., CNN blocks 910) to obtain a feature representation called f_i.
Step 2: In some examples, another neural network (e.g., an object detection network, such as an object detection head 925, etc.) may be used to obtain objects present in an image. Such objects may be denoted as [o1, o2, . . . , O_n}
Step 3: Once the objects are obtained, an extraction technique may be used (e.g., which extracts a subgraph from a real estate knowledge-graph, such as knowledge graph representation 930). This knowledge-graph may be created from real estate objects and manual labeling (e.g., where the subgraph may be denoted as G_i).
Step 4: Using the subgraph extracted from the knowledge graph, a concept embedding may be obtained through a graph convolutional network with attention. This concept embedding can be represented as C_i.
Step 5: Finally, concepts embedding C_i and f_i may be combined to create a final representation of the image.
Step 6: In some aspects, an attention based language model may be used to generate words from the final representation.

In some aspects, the encoder 905 may include convolutional layers (e.g., CNN blocks 910) to obtain a fixed representation of the image.

p(yₜ|y_{1:t-1})=softmax(Wₚhₜ²+bₚ)

The decoder is a sequence neural network to generate words describing the image. The input to the language model LSTM consists of the attended image feature, concatenated with the output of the attention LSTM, given by Using the notation y(1:T) to refer to a sequence of words (y1, . . . , yT), at each time step t the conditional distribution over possible output words is given by

$$p ( {y}_{1 : T} ) = {\prod }_{t = 1}^{T} p ( {y}_{t} \vert {y}_{1 : t - 1} )$$

Given a target ground truth sequence y(1:T) and a captioning model with parameters θ, we minimize the following cross entropy loss

$${L}_{XE} ( θ ) = - {\sum }_{t = 1}^{T} log ( {p}_{θ} ( {y}_{t}^{*} \vert {y}_{1 : t - 1}^{*} ) )$$

An LSTM is a form of RNN that includes feedback connections. In one example, LSTM blocks 920 may include a cell, an input gate, an output gate and a forget gate. The cell stores values for a certain amount of time, and the gates dictate the flow of information into and out of the cell. LSTM networks (e.g., LSTM blocks 920) may be used for making predictions based on series data where there can be gaps of unknown size between related information in the series. In some aspects, LSTMs may help mitigate the vanishing gradient (and exploding gradient) problems when training an RNN.

A GCN is a type of neural network that defines convolutional operation on graphs and uses their structural information. For example, a GCN may be used for node classification (e.g., documents) in a graph (e.g., a citation network), where labels are available for a subset of nodes using a semi-supervised learning approach. A feature description for every node is summarized in a matrix and uses a form of pooling operation to produce a node level output. In some cases, GCNs use dependency trees which enrich representation vectors for aspect terms and search for sentiment polarity of an input phrase/sentence.

The term “loss function” refers to a function that impacts how a machine learning model is trained in a supervised learning model. Specifically, during each training iteration, the output of the model is compared to the known annotation information in the training data. The loss function provides a value for how close the predicted annotation data is to the actual annotation data. After computing the loss function, the parameters of the model are updated accordingly and a new set of predictions are made during the next iteration.

Self-supervised learning is a type of learning where the model is trained using implicit signals present in the data. In these settings, information from the training data may be used to create labels to train a model. For example, an image can be rotated to create a rotated image. These rotated images and rotation angle can be used to train a base model. Once this model is trained, the representation from this model can be used to train other downstream models.

In some aspects, techniques described herein may implement self-supervised learning to pre-train CNN used in the image captioning models. For instance, different techniques may be applied, such as rotation, adding patches, etc. to create a training set for the self-supervised model. Once this model is trained, the CNN may be used as the encoder (e.g., image encoder 905, etc.) for the image captioning model. A benefit of this self-supervised learning pre-training technique is already trained CNN. This pretrained CNN may exhibit improved performance (e.g., compared to an untrained CNN model, which may lead to improved performance of our image captioning model).

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

As described herein, the learned representation may be used for downstream image classification tasks. Image classification models may use a feature Vector (e.g., which is passed through a softmax layer for final probability estimation of target classes). Since an accurate and detailed representation may be generated from the image captioning task, the image representation foot image classification model may be used. In an application layer, the image representations may be stored (e.g., such that an image captioning model representation does not have to be calculated again). Such image representations may be used to fine-tune the final classification layer for the image classification model.

FIG. 10 shows a flowchart 1000 of an example image search application according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Searching based on image similarity is a useful application in real estate web applications such as property search, property condition comparisons, etc. In some cases, users may use image search applications described herein to search similar real estate (e.g., similar properties, similar houses, etc.) based on an image (e.g., a search image that the user has on their mind). Image search applications described herein may more efficiently allow such users to search for visually similar properties, which may easily guide users to what they are looking for. Image-based information can also be helpful to augment traditional search processes where different tags can be added to the database to enrich the search process.

In some aspects, FIG. 10 illustrates example architectures and processes for implementation of visual information extraction from real estate images (e.g., to help users, or buyers, find desired properties). For instance, FIG. 10 shows one or more aspects of a pipeline of image vector creation by neural network (e.g., a ML model) from raw images. In the example flowchart 1000, once the query provides a query image (e.g., at operation 1020, an image vector from neural network (e.g., a query image vector) may be generated at 1025, and the query image vector may be used to search and obtain similar images. For instance, similar images may be searched at operation 1035 via image similarity indexing at operation 1035 (e.g., based on cosine similarity) and a list of one or more similar images may be output at operation 1040.

For instance, at operation 1005, the system creates a structured database with linked images from a property. For example an image database may contain a property identifier with a collection of images for the property. These images can range from different rooms outside the property, to different objects which are present in the house. In some cases, the operations of this step refer to, or may be performed by, a database as described with reference to FIG. 1. In some cases, the operations of this step refer to, or may be performed by, an image processing apparatus as described with reference to FIGS. 1-3, 6, and 8.

At operation 1010, the system extracts features from images in the image database, using a ML model (e.g., a neural network), and store these features (e.g., image feature vectors) as relevant metadata. In some examples, a pre-trained ML model (e.g., a neural network which was trained on large data set of real estate images) may be used. This ML model may include a stack of convolutional layers, batch normalization, drop out, and activation layers. In some examples, these neural networks may be trained on supervised loss function, and the neural networks may be used to extract features instead of extracting the final classification output. In some examples, the dimensionality of the extracted feature vector may be set to, for example, 256.

Batch normalization may be used to solve internal covariate shift within a neural network. During training, as the parameters of preceding layers change, the distribution of inputs to current layer changes accordingly. Thus, the current layer may constantly readjust to new distributions. This may be especially in deep networks, because small changes in hidden layers may be amplified as they propagate within the network. This may resulting in a significant shift in deeper hidden layers. Batch normalization may reduce unwanted shifts to speed up training and to produce more reliable models. In some cases, networks incorporating batch normalization can use a higher learning rate without vanishing or exploding gradients. Furthermore, batch normalization may regularizes a network so that it is easier to generalize. Thus, in some cases, it may be unnecessary to use dropout to mitigate overfitting. The network may also become more robust to different initialization schemes and learning rates. Batch normalization may be achieved by fixing the mean and variance of each layer's inputs. In some cases, the normalization may be conducted over an entire training set. In other cases, normalization is restrained to each mini-batch in the training process.

In some cases, the operations of step 1010 refer to, or may be performed by, a ML model as described with reference to FIGS. 1 and 3.

At operation 1015, the system stores the image feature vectors in the image data base. By converting the images into a low dimensional feature vector, the characteristic features about the images may be represented (e.g., in the vector space). In some cases, the operations of this step refer to, or may be performed by, a database as described with reference to FIG. 1. In some cases, the operations of this step refer to, or may be performed by, an image processing apparatus as described with reference to FIGS. 1-3, 6, and 8.

At operation 1020, the system obtains (e.g., or receive) a query image. For instance, as described herein, a user may submit or select a search image to be used to search for similar property listings, property or room designs, etc. In some cases, the operations of this step refer to, or may be performed by, an image processing apparatus as described with reference to FIGS. 1-3, 6, and 8. In some cases, the operations of this step refer to, or may be performed by, a camera as described with reference to FIG. 3. In some cases, the operations of this step refer to, or may be performed by, a ML model as described with reference to FIGS. 1 and 3.

At operation 1025, the system obtains a query image vector (e.g., via generating an embedded representation of the query image using the ML model). For instance, the input query image may be embedded in the vector space for comparison with image feature vectors extracted at operation 1010. In some cases, the operations of this step refer to, or may be performed by, a ML model as described with reference to FIGS. 1 and 3. In some cases, the operations of this step refer to, or may be performed by, an image encoder as described with reference to FIGS. 3 and 9.

At operation 1030, the system identifies (e.g., or search for) one or more candidate image feature vectors (e.g., based on the query image, other input from the user or the image search application, etc.). In some cases, the operations of this step refer to, or may be performed by, a search component as described with reference to FIG. 3.

At operation 1035, the system uses a similarity metric to compare the query image to candidate vectors from the image database including the image feature vectors. In some examples, cosine similarity may be used as a similarity metric (e.g., used to compare high dimensional feature vectors). For example, if two images are similar, then the cosine similarity between them may be low and if the images are not similar the cosine similarity may be high. In some cases, the operations of step 1035 refer to, or may be performed by, a search component as described with reference to FIG. 3. In some cases, the operations of step 1035 refer to, or may be performed by, a ML model as described with reference to FIGS. 1 and 3.

In some examples, various search indexing techniques may be implemented at operations 1010, 1015, 1030, and 1035. Search indexing is the process of structuring and parsing data to provide fast and accurate information retrieval. Files such as music, images, and text may be indexed based on associated tags or vector representations. When search indexing is performed, a computer program may search a large amount of information in a short period of time because the tags or vectors are compared rather than the information in the file itself.

At operation 1040, the system creates an approximate nearest neighbor index (e.g., based on the similarity of the feature vectors that have been extracted from the images). For instance, a high performance nearest neighbor algorithm may be used to create this index, which can search similar images at a very high speed based on the picture vectors. In some example, nearest neighbor search may be a machine learning algorithm applied at operation 1035. As described, given a feature vector, the goal is to find another object in the database which has closest feature vector according to a distance measure such as cosine similarity or Euclidean distance. In some examples, once the key nearest feature vectors and their corresponding image IDs have been extracted, the results may be displayed to the user. In some cases, K nearest neighbor index creation techniques may be applied (e.g., K-nearest neighbor image finding processes) to produce the result to show the output to the user. In some cases, the operations of this step refer to, or may be performed by, a search component as described with reference to FIG. 3. In some cases, the operations of this step refer to, or may be performed by, a ML model as described with reference to FIGS. 1 and 3.

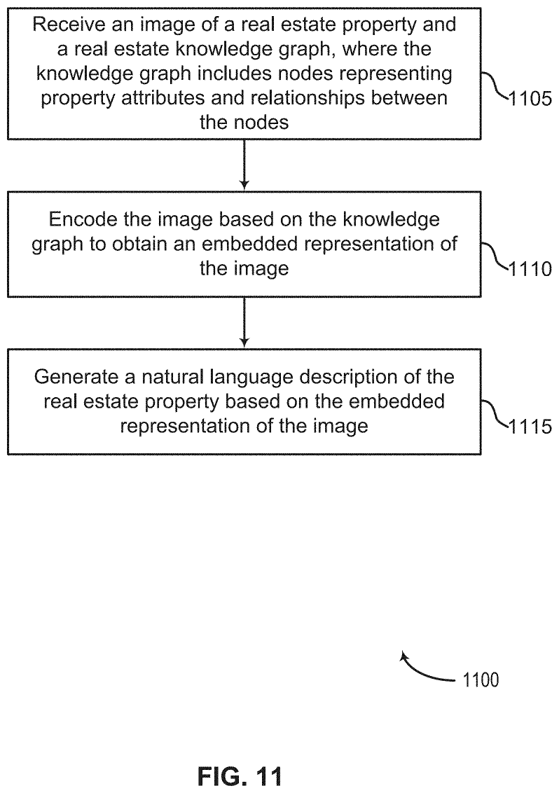

FIG. 11 shows an example of a method 1100 for real estate applications leveraging artificial intelligence techniques according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system receives an image of a real estate property and a real estate knowledge graph, where the knowledge graph includes nodes representing property attributes and relationships between the nodes. In some cases, the operations of this step refer to, or may be performed by, a ML model as described with reference to FIGS. 1 and 3.

At operation 1110, the system encodes the image based on the knowledge graph to obtain an embedded representation of the image. In some cases, the operations of this step refer to, or may be performed by, an image encoder as described with reference to FIGS. 3 and 9.

At operation 1115, the system generates a natural language description of the real estate property based on the embedded representation of the image. In some cases, the operations of this step refer to, or may be performed by, a caption network as described with reference to FIG. 3.

Moreover, an apparatus, non-transitory computer readable medium, and system for implementing a computer vision framework for real estate applications are described. One or more aspects of the apparatus, non-transitory computer readable medium, and system include receiving an image of a real estate property and a real estate knowledge graph, wherein the knowledge graph includes nodes representing property attributes and relationships between the nodes; encoding the image based on the knowledge graph to obtain an embedded representation of the image; and generating a natural language description of the real estate property based on the embedded representation of the image.

Some examples of the method, apparatus, non-transitory computer readable medium, and system further include identifying a plurality of room types and a plurality of objects within the room types, wherein the nodes of the knowledge graph include the plurality of room types and the plurality of objects within the room types. Some examples of the method, apparatus, non-transitory computer readable medium, and system further include identifying an object attribute for each of the plurality of objects, wherein the nodes of the knowledge graph include the object attribute.

Some examples of the method, apparatus, non-transitory computer readable medium, and system further include performing a convolution operation on the image to obtain a convolution representation, wherein the embedded representation of the image is based on the convolution representation. Some examples of the method, apparatus, non-transitory computer readable medium, and system further include applying a transformer network to the image to obtain a transformer representation, wherein the embedded representation of the image is based on the transformer representation.

Some examples of the method, apparatus, non-transitory computer readable medium, and system further include applying a knowledge transformer network to the knowledge graph to obtain an embedded representation of the knowledge graph, wherein the embedded representation of the image is based on the embedded knowledge representation.

Some examples of the method, apparatus, non-transitory computer readable medium, and system further include applying an RNN to the embedded representation of the image to obtain the natural language description.

Some examples of the method, apparatus, non-transitory computer readable medium, and system further include receiving a search query that includes attributes of the real estate property. Some examples further include retrieving the image based on the search query and the embedded representation of the image.

Some examples of the method, apparatus, non-transitory computer readable medium, and system further include performing object detection on the image based on the embedded representation of the image to obtain an image tag corresponding to an object represented in the knowledge graph.

Some examples of the method, apparatus, non-transitory computer readable medium, and system further include classifying the image based on a set of real estate property types based on the embedded representation of the image.

Some examples of the method, apparatus, non-transitory computer readable medium, and system further include generating a real estate listing that includes the image and the natural language description. Some examples further include displaying the real estate listing on a website. Some examples of the method, apparatus, non-transitory computer readable medium, and system further include generating a description of a maintenance condition of the real estate property based on the embedded representation of the image.

Some examples of the method, apparatus, non-transitory computer readable medium, and system further include encoding a user profile of a user to obtain an encoded user profile. Some examples further include generating a recommendation score based on the embedded representation of the image and the encoded user profile. Some examples further include recommending the real estate property to the user based on the recommendation score.

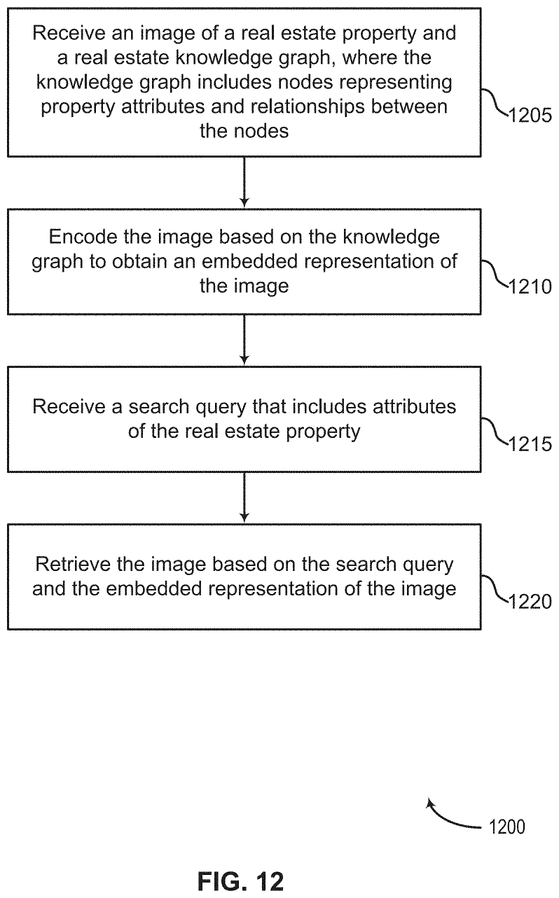

FIG. 12 shows an example of a method 1200 for real estate applications leveraging artificial intelligence techniques according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system receives an image of a real estate property and a real estate knowledge graph, where the knowledge graph includes nodes representing property attributes and relationships between the nodes. In some cases, the operations of this step refer to, or may be performed by, a ML model as described with reference to FIGS. 1 and 3.

At operation 1210, the system encodes the image based on the knowledge graph to obtain an embedded representation of the image. In some cases, the operations of this step refer to, or may be performed by, an image encoder as described with reference to FIGS. 3 and 9.

At operation 1215, the system receives a search query that includes attributes of the real estate property. In some cases, the operations of this step refer to, or may be performed by, a search component as described with reference to FIG. 3.

At operation 1220, the system retrieves the image based on the search query and the embedded representation of the image. In some cases, the operations of this step refer to, or may be performed by, a search component as described with reference to FIG. 3.

Moreover, an apparatus, non-transitory computer readable medium, and system for implementing a computer vision framework for real estate applications are described. One or more aspects of the apparatus, non-transitory computer readable medium, and system include receiving an image of a real estate property and a real estate knowledge graph, wherein the knowledge graph includes nodes representing property attributes and relationships between the nodes; encoding the image based on the knowledge graph to obtain an embedded representation of the image; receiving a search query that includes attributes of the real estate property; and retrieving the image based on the search query and the embedded representation of the image.

Some examples of the method, apparatus, non-transitory computer readable medium, and system further include encoding the search query in a same embedding space as the image to obtain an encoded search query. Some examples further include generating a similarity score between the image and the search query, wherein the image is retrieved based on the similarity score. In some aspects, the search query comprises an image, a text description, or both.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described systems and methods may be implemented or performed by devices that include a general-purpose processor, a DSP, an ASIC, a FPGA or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise RAM, ROM, electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
receiving an image of a real estate property and a real estate knowledge graph, wherein the knowledge graph includes nodes representing property attributes and relationships between the nodes;
encoding the image based on the knowledge graph to obtain an embedded representation of the image; and
generating a natural language description of the real estate property based on the embedded representation of the image.

2. The method of claim 1, further comprising:
identifying a plurality of room types and a plurality of objects within the room types, wherein the nodes of the knowledge graph include the plurality of room types and the plurality of objects within the room types.

3. The method of claim 1, further comprising:
identifying an object attribute for each of the plurality of objects, wherein the nodes of the knowledge graph include the object attribute.

4. The method of claim 1, further comprising:
performing a convolution operation on the image to obtain a convolution representation, wherein the embedded representation of the image is based on the convolution representation.

5. The method of claim 1, further comprising:
applying a transformer network to the image to obtain a transformer representation, wherein the embedded representation of the image is based on the transformer representation.

6. The method of claim 1, further comprising:
applying a knowledge transformer network to the knowledge graph to obtain an embedded representation of the knowledge graph, wherein the embedded representation of the image is based on the embedded knowledge representation.

7. The method of claim 1, further comprising:
applying an RNN to the embedded representation of the image to obtain the natural language description.

8. The method of claim 1, further comprising:
receiving a search query that includes attributes of the real estate property; and
retrieving the image based on the search query and the embedded representation of the image.

9. The method of claim 1, further comprising:
performing object detection on the image based on the embedded representation of the image to obtain an image tag corresponding to an object represented in the knowledge graph.

10. The method of claim 1, further comprising:
classifying the image based on a set of real estate property types based on the embedded representation of the image.

11. The method of claim 1, further comprising:
generating a real estate listing that includes the image and the natural language description; and
displaying the real estate listing on a website.

12. The method of claim 1, further comprising:
generating a description of a maintenance condition of the real estate property based on the embedded representation of the image.

13. The method of claim 1, further comprising:
encoding a user profile of a user to obtain an encoded user profile;
generating a recommendation score based on the embedded representation of the image and the encoded user profile; and
recommending the real estate property to the user based on the recommendation score.

14. A method comprising:
receiving an image of a real estate property and a real estate knowledge graph, wherein the knowledge graph includes nodes representing property attributes and relationships between the nodes;
encoding the image based on the knowledge graph to obtain an embedded representation of the image;
receiving a search query that includes attributes of the real estate property; and
retrieving the image based on the search query and the embedded representation of the image.

15. The method of claim 14, further comprising:
encoding the search query in a same embedding space as the image to obtain an encoded search query; and
generating a similarity score between the image and the search query, wherein the image is retrieved based on the similarity score.

16. The method of claim 14, wherein:
the search query comprises an image, a text description, or both.

17. An apparatus comprising:
a knowledge transformer network configured to encode a real estate knowledge graph comprising nodes representing property attributes and relationships between the nodes to obtain an embedded knowledge representation;
an image encoder configured to encode an image of a real estate property based on the embedded knowledge representation to obtain an embedded representation of the image; and
a caption network configured to generate a natural language description of the real estate property based on the embedded representation of the image.

18. The apparatus of claim 17, further comprising:
a search component configured to retrieve the image based on a search query.

19. The apparatus of claim 17, further comprising:
a property classification head configured to classify the image according to a set of real estate property types based on the embedded representation of the image.

20. The apparatus of claim 17, further comprising:
an object detection head configured to identify an object in the image based on the embedded representation of the image.
